(19) United States
(12) Patent Application Publication
(10) Pub. No.: US 2012/0061589 A1
(43) Pub. Date: Mar. 15, 2012

(54) METHOD AND APPARATUS FOR MEASURING FLUORESCENT MATERIAL IN A LIQUID

(75) Inventors: Khalid Thabeth, County Antrim (GB); Frank Lunney, Belfast (GB); Turan Mirza, Lisburn (GB)

(73) Assignee: ADVANCED SENSORS LIMITED, Carrickfergus, County Antrim (GB)

(21) Appl. No.: 13/321,061

(22) PCT Filed: May 14, 2010
(86) PCT No.: PCT/EP10/02976

§ 371 Date: Nov. 17, 2011

(30) Foreign Application Priority Data
May 19, 2009 (GB) 0908527.5

(51) Int. Cl. G01N 21/64

(52) U.S. Cl. 250/459.1; 250/458.1; 250/461.1; 356/326

(57) ABSTRACT

A method of measuring the amount of a fluorescent material in a liquid comprising the steps of exciting the fluorescent material and measuring the fluorescent response of the material over a range of wavelengths to determine a response spectrum, identifying the material from the response spectrum and determining the amount of material as a function of the amplitude of the fluorescent response and a calibration factor based upon the identification of the material.

### CROSS REFERENCE TO RELATED APPLICATION

The present application claims the priority benefits of International Patent Application No. PCT/EP2010/002976, filed on May 14, 2010, and also of Great Britain Application No. GB0908527.5, filed on May 19, 2009, which are hereby incorporated herein by reference in their entireties.

### BACKGROUND OF THE INVENTION

This invention relates to an apparatus and method for measuring the amount of a fluorescent material in a liquid, in particular, to the measurement of oil in a liquid, such as water.

There are many applications that require measurement of the amount or concentration of oil that is present in a liquid. For example, in pipes leading from oil production or refining facilities it may be required to measure the amount of oil that is present in the liquid (mainly water) flowing in the pipes. To this end it is known to provide an apparatus which measures the amount or concentration of oil that is present.

Many oils have a natural fluorescence and so, commonly, such measurement apparatus measure the amount or concentration of oil by the detection of fluorescence. Apparatus that detect and/or measure fluorescence are commonly referred to as fluorometers. A fluorometer usually includes a light source for causing excitation of a target substance and a detector for measuring the resultant fluorescence of the target substance at a predetermined wavelength.

EP 1991856, corresponding to U.S. Patent Pub. No. 2009/0032733, (incorporated herein by reference) discloses a fluorometer for determining the amount of oil, or other fluorescent material, in a liquid, such as water.

### SUMMARY OF THE INVENTION

According to a first aspect of the present invention there is provided an apparatus for measuring the amount of a fluorescent material in a liquid comprising an excitation source for exciting said fluorescent material, a detector for detecting the fluorescent response of the material over a range of wavelengths to determine a response spectrum, and a processing device for identifying the material based upon its response spectrum and for determining the amount of said material as a function of the amplitude of the fluorescent response, preferably at a predetermined wavelength, and a calibration factor based upon said identification of the material.

In particular embodiments the detector comprises a spectrometer.

The excitation source may comprise a light source of any suitable wavelength and may comprise a UV light source. In one embodiment, the excitation source comprises a laser source, such as a continuous wave laser source. In one embodiment the excitation source comprises a 3 mW laser diode module of 405 nm wavelength.

In particular embodiments the processing device comprises a microprocessor.

In one embodiment, said apparatus includes a full scan UV to IR spectrometer for determining said response spectrum.

According to a further aspect of the present invention there is provided a method of measuring the amount of a fluorescent material in a liquid, said method comprising the steps of exciting said fluorescent material and measuring the fluorescent response of the material over a range of wavelengths to determine a response spectrum, identifying the material from said response spectrum and determining the amount of said material as a function of the amplitude of the fluorescent response, preferably at a predetermined wavelength, and a calibration factor based upon said identification of the material.

According to a further aspect of the present invention there is provided a method of calibrating a fluorometer for measuring the amount of a fluorescent material in a liquid, said method comprising identifying said fluorescent material to be measured and selecting a calibration factor, based upon said identification, to be used to determine the amount of said fluorescent material.

In particular embodiments said step of identifying said fluorescent material comprises exciting said fluorescent material and measuring the fluorescent response of the material over a range of wavelengths to determine a response spectrum and identifying the material from said response spectrum. Preferably said identification step comprises comparing the determined response spectrum to a series of reference response spectra for known materials to determine the best match.

An embodiment of the present invention will now be described, by way of example only.

### BRIEF DESCRIPTION OF THE DRAWINGS

FIG. 1 shows the optical spectra of sample oils at 50 ppm concentration in water;

FIG. 2 shows an example of the different response spectra for different species of oil; and

FIG. 3 schematically illustrates an apparatus for measuring fluorescence in a liquid.

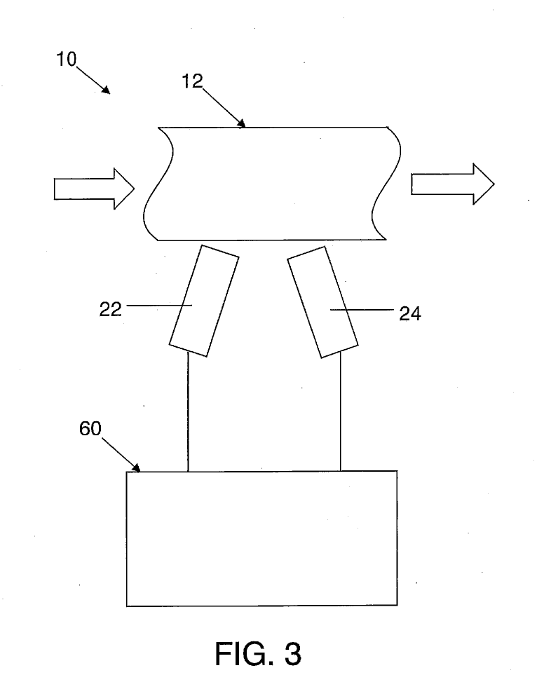

### DESCRIPTION OF PREFERRED EMBODIMENTS

In an embodiment of the present invention, an apparatus for measuring fluorescence in a liquid comprises an in-line fluorometer for incorporation, in use, into a pipe or conduit through which a liquid (e.g. water) including a fluorescent material (e.g. oil) flows. In the following description, the liquid is assumed to comprise water and the fluorescent material is assumed to comprise oil, although it will be understood that that the invention is not limited to these. For example, the target substance to be detected may be naturally fluorescent and/or may include an added fluorescent agent such as fluorescein.

The apparatus 10 comprises a measurement chamber 12, which may be provided by a section of pipe or conduit that is separately formed from the pipe or conduit but is adapted for in-line connection therewith using any suitable conventional connectors (not shown). The apparatus 10 may be of the type shown in EP 1991856 and therefore need not be described in more detail herein. The apparatus 10 comprises an excitation source 22 in the form of a 3 mW laser diode module of 405 nm wavelength and a detector 24 for detecting the fluorescent response of a target material over a range of frequencies to produce a response spectrum for the material.

The detector 24 may comprise an inbuilt full scan UV to IR spectrometer for determining the fluorescent response of the target substance over a range of wavelengths, such as over the full optical spectrum, typically between around 370 nm and 1000 nm.

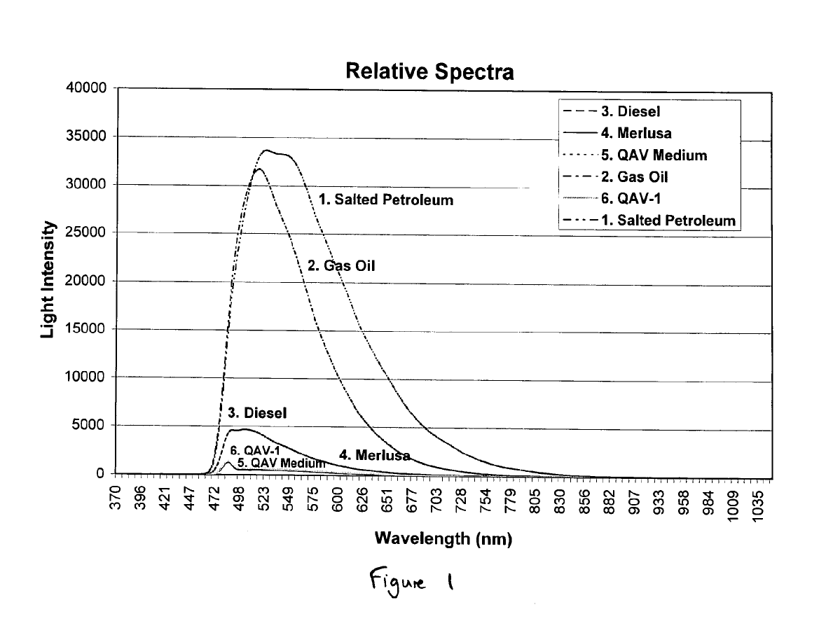

FIG. 1 shows the optical spectra of sample oils all at 50 ppm concentration in water. As can be seen, there is a vast difference in the amplitude of measured fluorescence between different oils at the same concentration. Therefore a known fluorometer calibrated for one species of oil will produce inaccurate results when a different species of oil is present in the liquid. For example, when calibrated for a QAV medium, a concentration of 650 ppm will be indicated with Salted Petroleum, even though only 10 ppm is actually present, due to the much greater amplitude of fluorescence of Salted Petroleum compared to QAV.

The improved fluorometer in accordance with an embodiment of the invention measures the fluorescent response of a material in a liquid over a range of wavelengths (for example from approximately 400 nm to 100 nm or substantially over the entire optical spectrum) by means of the inbuilt full scan UV to IR spectrometer. The apparatus 10 includes a microprocessor 60 programmed to analyse the shape or profile of the measured spectrum and compare the measured curve to that of known spectra from calibrated samples by the inbuilt software to find a best match, identifying the species of oil present.

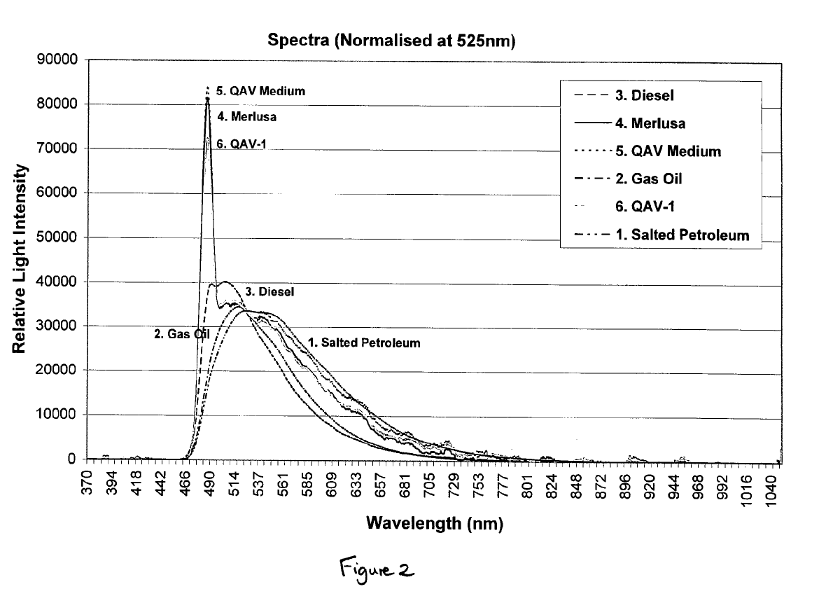

FIG. 2 shows an example of the different response spectra for different species of oil. The software may apply a gain factor to the response spectra to adjust the amplitude of the response spectra to enable the profile of the response spectra to be analysed and compared to reference spectra of known materials to allow the identity of the material to be determined.

Based upon such material identification the software selects a predetermined calibration factor corresponding to the material identified, and provides a measure of the concentration of the material identified as a function of the amplitude of the fluorescent response at a predetermined wavelength and the calibration factor to provide an accurate measure of the concentration of the oil present. Thus the fluorometer in accordance with the present invention is capable of automatic identification of the oil species present and automatic calibration to provide an accurate determination of the concentration of said oil.

The amplitude of the fluorescent response of the material at said predetermined wavelength, used to determine the concentration of the material, may be determined from the inbuilt detector of the spectrometer or by means of a further detector filtered to detect fluorescence at said predetermined wavelength.

While the present invention has been described in relation to an apparatus for determining the identity and amount or concentration of oil in a liquid, it can equally be applied to the identification and measurement of concentration/amount of any other fluorescent material in a liquid.

The invention is not limited to the embodiment(s) described herein but can be amended or modified without departing from the scope of the present invention.

1. An apparatus for measuring the amount of a fluorescent material in a liquid comprising an excitation source for exciting said fluorescent material, a detector for detecting the fluorescent response of the material over a range of wavelengths to determine a response spectrum, and a processor for identifying the material based upon its response spectrum and for determining the amount of said material as a function of the amplitude of the fluorescent response and a calibration factor based upon said identification of the material.

2. An apparatus as claimed in claim 1, wherein said processor determines the amount of said material as a function of the amplitude of the fluorescent response at a predetermined wavelength.

3. An apparatus as claimed in claim 1, wherein the detector comprises a spectrometer.

4. An apparatus as claimed in claim 3, wherein said spectrometer comprises a full scan UV to IR spectrometer.

5. An apparatus as claimed in claim 1, wherein the excitation source comprises a light source.

6. An apparatus as claimed in claim 5, wherein said excitation source comprises a UV light source.

7. An apparatus as claimed in any preceding claim 1, wherein the excitation source comprises a laser source.

8. An apparatus as claimed in claim 7, wherein the excitation source comprises a continuous wave laser source.

9. An apparatus as claimed in claim 7, wherein the excitation source comprises a 3 mW laser diode module of 405 nm wavelength.

10. An apparatus as claimed in claim 1, wherein said processor comprises a microprocessor.

11. A method of measuring the amount of a fluorescent material in a liquid, said method comprising the steps of exciting said fluorescent material and measuring the fluorescent response of the material over a range of wavelengths to determine a response spectrum, identifying the material from said response spectrum and determining the amount of said material as a function of the amplitude of the fluorescent response and a calibration factor based upon said identification of the material.

12. A method as claimed in claim 11, wherein the amount of material is determined as a function of the amplitude of the fluorescent response at a predetermined wavelength.

13. A method of calibrating a fluorometer for measuring the amount of a fluorescent material in a liquid, said method comprising identifying said fluorescent material to be measured and selecting a calibration factor, based upon said identification, to be used to determine the amount of said fluorescent material.

14. A method as claimed in claim 13, wherein said step of identifying said fluorescent material comprises exciting said fluorescent material and measuring the fluorescent response of the material over a range of wavelengths to determine a response spectrum and identifying the material from said response spectrum.

15. A method as claimed in claim 14, wherein said identification step comprises comparing the determined response spectrum to a series of reference response spectra for known materials to determine the best match.
